(19) United States
(12) Patent Application Publication
(10) Pub. No.: US 2022/0321427 A1
(43) Pub. Date: Oct. 6, 2022

(54) DATA STORAGE SYSTEM WITH INTELLIGENT POLICY DECISIONS

(71) Applicant: Seagate Technology LLC, Fremont, CA (US)

(72) Inventor: Saisubrahmanyam Bhupasamudram Narasimhamurthy, Haywards Heath (GB)

(21) Appl. No.: 17/301,527

(22) Filed: Apr. 6, 2021

(51) Int. Cl. H04L 12/24; H04L 29/08

(52) U.S. Cl. CPC H04L 41/5006; H04L 67/1097

(57) ABSTRACT

A data storage system may receive a request to conform to a service level agreement from a host. A service module connected between the host and at least one memory evaluates the request in view of at least one current system performance model and at least one predicted system performance model. The service module rejecting the request in response to a performance cost associated with adjusting current system settings to satisfying the service level agreement. The performance cost and at least one setting adjustment operation each associated with the current system settings and each generated by the service module.

### SUMMARY

A data storage system, in accordance with assorted embodiments, connects a service module to at least one host and a memory before modeling a first storage performance metric with the service module in accordance with a modeling strategy. Receipt of a request for a new service level agreement to the memory prompts the service module to evaluate an impact of the new service level agreement on an ability to guarantee existing service level agreements to the memory based on at least the first storage performance metric. The service module decides to accept or deny the request for the new service level agreement in response to the impact of the new service level agreement on the ability to guarantee existing service level agreements to the memory.

Other embodiments of a data storage system connect a service module to at least one host and a memory before modeling a first storage performance metric with the service module in accordance with a modeling strategy. Receipt of a request for a new service level agreement to the memory prompts the service module to generate a storage setting of the memory to satisfy the new service level agreement and evaluate an impact of the new service level agreement and setting on an ability to guarantee existing service level agreements to the memory based on at least the first storage performance metric. The service module decides to accept or deny the request for the new service level agreement in response to the impact of the new service level agreement on the ability to guarantee existing service level agreements to the memory.

A service module of a data storage system is connected to at least one host and a memory with circuitry that models more than one data storage performance metric and decides to accept or deny a request for a new service level agreement to the memory after evaluating an impact of the new service level agreement on an ability to guarantee existing service level agreements to the memory.

### BRIEF DESCRIPTION OF THE DRAWINGS

FIG. 1 displays a block representation of an example data storage system in which various embodiments may be practiced.

FIG. 2 is a block representation of portions of an example data storage system operated in accordance with assorted embodiments.

FIG. 3 depicts a block representation of portions of an example data storage system utilized in accordance with some embodiments.

FIG. 4 conveys a block representation of portions of an example data storage system carrying out embodiments of dynamic permission evaluation.

FIGS. 5A and 5B respectively represent an example data storage system configured and operated in accordance with various embodiments.

FIG. 6 depicts a block representation of an example module that can be utilized in a data storage system to carry out assorted embodiments.

FIG. 7 conveys a flowchart of an example SLA request routine that can be executed by the embodiments of a data storage system illustrated in FIGS. 1-6.

### DETAILED DESCRIPTION

Assorted embodiments are directed to the intelligent evaluation of requests to satisfy service level agreements with a data storage system. Through the intelligent evaluation of current system performance and modeling how new service level agreements would impact future system performance, a data storage system can accept, or reject, a service level agreement request with an understanding of how satisfying the request affects future system performance capabilities.

The evolution of cloud data storage, and other systems utilizing remote memory, has allowed numerous different hosts to utilize large volumes of data storage. The assorted hosts in a cloud data storage environment can request various data access and cost parameters associated with the utilization of the cloud memory. Such requests can be characterized as service level agreements (SLAs). SLAs are contractual agreements between cloud service providers (CSPs) and their clients regarding the quality of service (QoS) when retrieving data. For example, an SLA can address data transfer latency, error rate, cost of data storage, write latency, and/or buffer utilization individually, or collectively, such as with throughput or bandwidth, which can be the same data transfer latency and write latency. It is noted that buffer utilization is a side effect of an SLA request that is not conventionally included in an SLA request. Per the SLA, a client/host pays for a guarantee that the terms of the SLA are satisfied during the term of the SLA, otherwise there are financial consequences to the CSP. The cost of an SLA request can also be a side effect and can involve a number of different parameters, such as higher throughput being associated with greater expense and money being spent compared to lower throughput that can be associated with less expense for data storage and retrieval.

Quality of service is a feature in systems that enable the acceptance, or rejection, of the terms of an SLA, such as data throughput, latency, or jitter. However, existing SLA decisions do not account for the impact of the SLA or the capabilities of the data storage system. Thus, embodiments of this disclosure derive a performance model of a data storage system to intelligently evaluate the SLA and determine if the SLA should be accepted or rejected.

While satisfying a single SLA can be relatively straightforward, connecting greater numbers of different hosts in a data storage system can greatly complicate data management and servicing data access requests to satisfy multiple different SLAs with varying terms. The ability to guarantee data storage and access performance currently may drastically change in the future, particularly with the acceptance of new, additional SLAs by the data storage system. A difficulty with the SLA business model is that the data transfer latency needs of a client/host can vary over time for various amounts and types of data. It is noted that latency is how quickly requested commands are executed by a data storage system and throughput is how much data per second can be written to, or read from, a data storage system. For instance, a client collecting large amounts of data for business analytics will have stringent data latency requirements soon after the data is collected, such as when real-time data analysis is being conducted. However, after a given amount of time, the data is not accessed as frequently and becomes stale, which does not require as stringent data transfer latency. In this situation, the client/host is in a conundrum as to whether or not pay higher costs per unit of data storage to ensure low data transfer latency or suffer relatively high data transfer latency with a lower cost per unit of data storage (MB, GB, TB, etc.).

With these challenges in handling SLAs in mind, various embodiments configure a service module to dynamically model current data storage system performance and capabilities to efficiently determine how a new SLA request will impact the capabilities and performance of the system. The service module can predict what calibration changes can be made to satisfy a new SLA and what impact those calibration changes would have on satisfying existing SLAs. As a result, the service module can provide dynamic SLA evaluation that leads to intelligent SLA permissions and servicing policies.

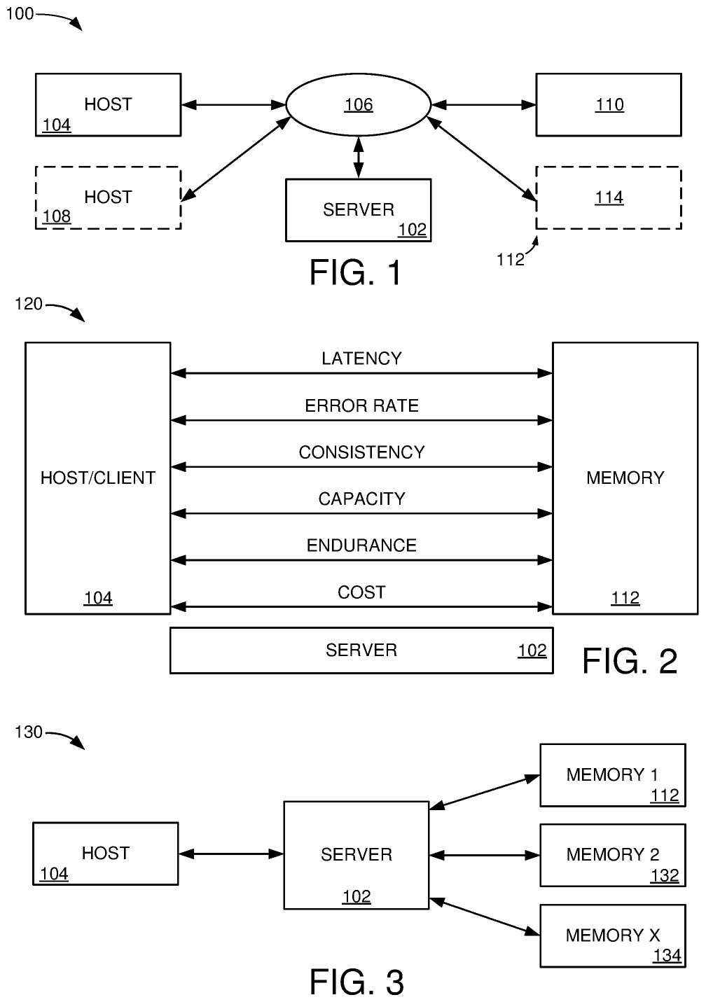

FIG. 1 displays an example data storage system 100 where assorted aspects of the present disclosure can be practiced in accordance with some embodiments. The system 100 has at least one data storage server 102 connected to one or more hosts 104 via a wired or wireless network 106. A data storage server 102 can temporarily and permanently store data that can be retrieved by a local, or remote, host 104 at will. It is contemplated that the network 106 allows multiple hosts 104 and 108 to concurrently, or independently, access the data storage server 102, such as to transfer data into, or out of, one or more devices 110 that comprise a system memory 112. That is, numerous, physically separate, devices 110, as illustrated by segmented data storage device 114, can be utilized collectively as a single memory 112 through the configuration and utilization of the server 102.

The ability to connect the data storage server 102 to any number of remote hosts 104/108 allows the data storage system 100 to service a number of different clients concurrently. However, such connectivity often corresponds with increasing amounts of data with varying SLAs, quality of service (QoS), and capacity needs and/or requirements. FIG. 2 depicts portions of an example data storage system 120 arranged to carry out various embodiments of intelligent and dynamic SLA permissions. It is noted that the data storage system 120 is shown with a single host 104 accessing a memory 112 via a network server 102, such configuration is not required or limiting as numerous hosts 104 can be connected to multiple memories 112 via more than one network server 102.

The configuration of the server 102 can allow for various operational parameters to be maintained over time in the memory 112 and/or hosts 104 to satisfy an SLA, which corresponds to a QoS. For example, the server 102 can alter, manipulate, prioritize, and/or arrange data access requests, background operations, and data to provide performance metrics that meet, or exceed, the metrics prescribed by the SLA, such as data access latency, data error rate, data latency consistency over time, available data capacity, memory cell endurance, and/or cost of data storage over time. That is, an SLA can prescribe a range, or threshold value, for how fast data is written/read in response to a host request (latency), how many errors are encountered (error rate), how much variability there is between latency for different data access requests (consistency), how much space is available at any one time (capacity), how long data is stored in the same portion of memory (endurance), and how much money a host/client will incur through the storage of data (cost).

While not required or limiting, the ability of a data storage system 120 to guarantee performance to satisfy the assorted terms of the SLA allows for increased numbers of clients to be serviced, which provides greater value for the host/clients 104 and greater profits for the business supplying data storage. FIG. 3 conveys a block representation of how multiple memories 112/132/134 can be utilized by a system server 102 to better satisfy one or more SLAs. In accordance with various embodiments, a system server 102 can manage and carry out one or more SLAs to one or more memories 112/132/134 that exhibit different memory capabilities and/or data storage performance.

A non-limiting example involves the server 102 satisfying a single SLA with a single host/client 104 by manipulating which memory 112/132/134 receives write data. It is noted that a host 104 can be positioned outside a data storage system and not considered part of a memory 112/132/134. While various embodiments consider a storage system as an aggregate of all connected memories 112/132/134, any number of additional memories can be incorporated into a single operational data repository. The ability to select different memories 112/132/134 with different operational capabilities and/or performance allows the server 102 to optimize the efficiency associated with carrying out the SLA, such as maintaining a system capability to service and satisfy additional SLAs to additional hosts/clients 104. The availability of memories 112/132/134 with different capabilities and performance further allows the server 102 to conduct different calibrations and/or background operations on some portions of memory, such as a plane, die, or data storage device, while other portions of memory 112/132/134 are utilized to continually satisfy the SLA.

Although a single SLA can be optimally satisfied with the data storage system 130, some embodiments employ the server 102 to concurrently satisfy multiple different SLAs, which may have originated from one or more hosts/clients 104. The availability of different memories 112/132/132, or portions of a single memory 112/132/134, that exhibit different capabilities and/or data access performance allows the server 102 to segregate different SLAs to different memories 112/132/134, utilize a portion of memory for multiple different SLAs, and alter how SLAs are satisfied based on changing memory, or operational, conditions. With the ability to dynamically execute multiple SLAs to one or more memories 112/132/134, the server 102 can choose to accept, or deny, requests for the system 130 to service new and/or additional SLAs from one or more different hosts/clients 104.

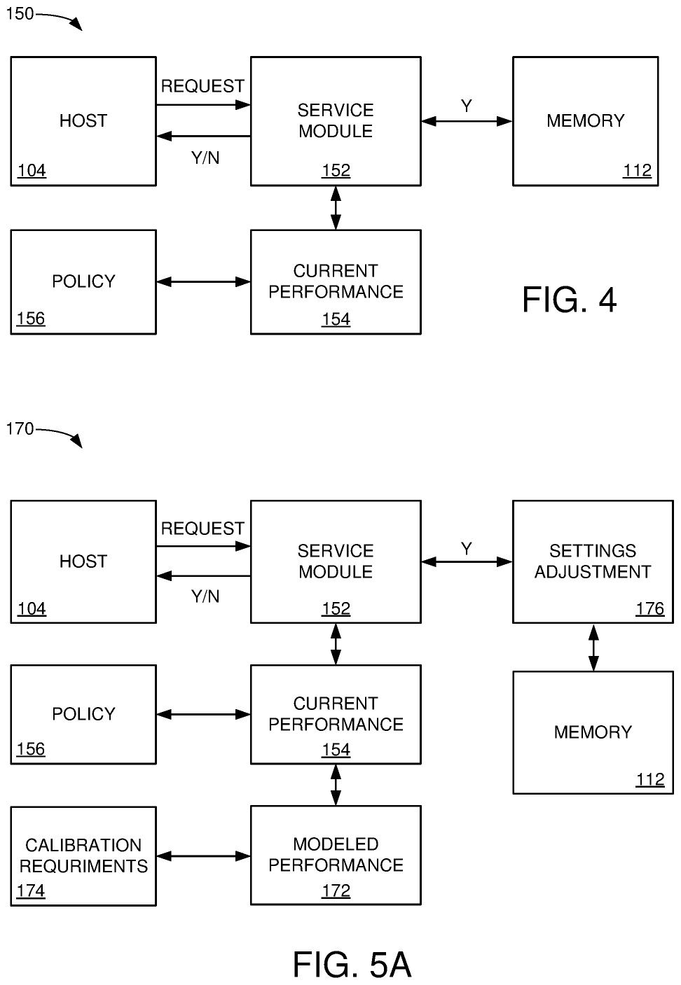

FIG. 4 depicts a block representation of portions of an example data storage system 150 arranged to carry out assorted embodiments of SLA execution. As shown, a service module 152 is connected between a host/client 104 and at least one memory 112, which may consist of one or more separate data storage devices in one or more different physical locations. The service module 152 may be resident in hardware and/or software in a system server, such as server 102, but is not required to be solely confined to a server. That is, the service module 152 may utilize hardware and/or software aspects resident in multiple different components and/or locations of the data storage system 150.

The service module 152, in some embodiments, comprises circuitry that evaluates the current data access/storage performance of the data storage system 150. Such circuitry can determine the current, real-time performance of the system 150 by monitoring existing data access operations and/or generating test patterns of data reads, data writes, and/or background memory operations. The current performance of the system 150 may have any resolution, such as by memory 112, die, plane, page, memory cell, data sector, data block, data storage device, or pool of data storage devices. With tighter resolution, the service module 152 can more accurately determine if, and how, the system 150 could service a request for a new SLA (request). However, such increased resolution can expend greater system resources, such as power, time, and processing resources. Hence, the service module 152 can choose a performance resolution in view of the current load, available resources, and sophistication of the requested SLA in order to provide the most accurate understanding of the current performance of the system 150 that corresponds with an accurate determination if the system 150 can guarantee to satisfy the requested SLA.

Through the balancing of expended system resources to determine the current system performance and the accuracy of the performance determination, the service module 152 can choose whether to accept or deny the new SLA request based on one or more SLA policies 156. An SLA policy can be a static evaluation of one or more performance parameters that are determined from the current system performance 154, from current memory configurations, and/or from current system configurations. For example, a policy 156 can prompt the service module 152 to accept or deny a new SLA request based on how existing memory is arranged, such as type of memory, available memory capacity, error rate of memory cells, memory endurance, and 3D memory stacking.

The evaluation of new SLA requests in view of current system performance and capabilities can provide intelligent approval, or denial, of SLAs that can be efficiently accommodated, or that will jeopardize the guaranteed metrics of other SLAs. Yet, the static approval/denial policy 156 can prove inaccurate over time despite being based on current system performance and/or capabilities, particularly in systems with volatile data access volume, numerous concurrent SLAs, and/or numerous connected, active client/hosts 104. Accordingly, embodiments of the service module 152, and system server 102, provide intelligent evaluation and decisions with respect to new SLA requests to a data storage system based on dynamic system modeling as well as dynamic policy permissions that determine if a new SLA request is accepted or denied.

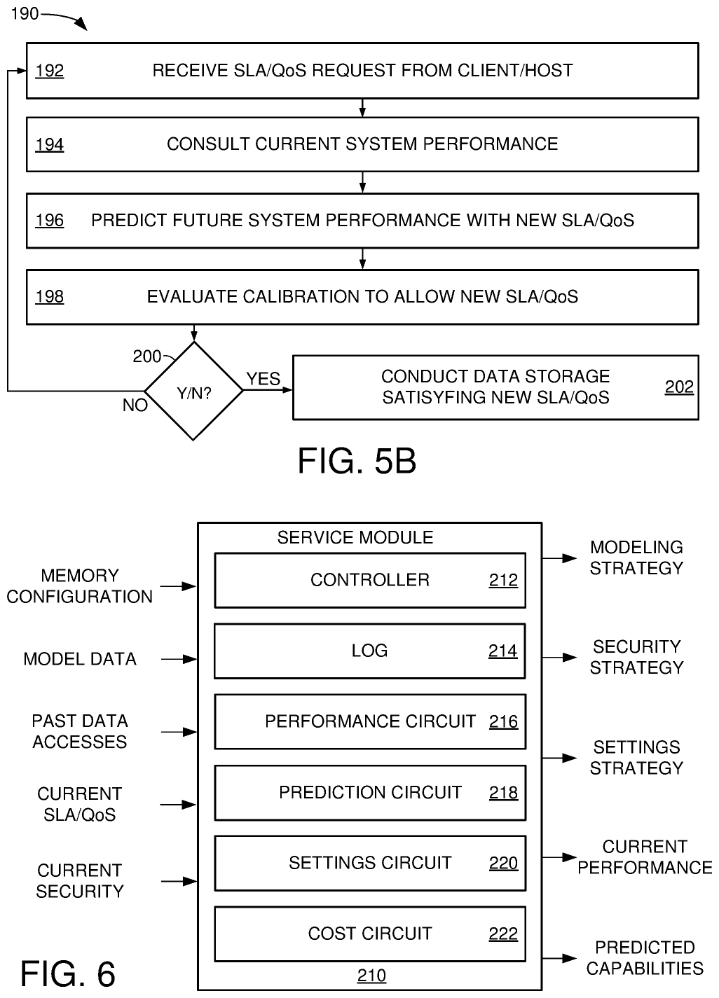

FIGS. 5A and 5B respectively depict aspects of an example data storage system 170 that is configured to carry our various embodiments of intelligent SLA evaluation and dynamic SLA policy permissions. In FIG. 5A, a service module 152 consists of circuitry to determine the current performance and data access capabilities of at least one memory 112 of the system at a dynamic resolution and circuitry that dynamically models future system performance and capabilities 172. The current and modeled future system performance allows the service module 152 to determine what, if any, system calibrations 174 are required to reliably satisfy existing and any new SLAs.

It is noted that changing system calibrations to satisfy new SLA requests can be difficult and complicated due to a storage system being universally calibrated to work best for all possible types of applications. The assorted embodiments of a service module focus primarily on making an intelligent decision on whether to accept or reject an SLA request. The storage system, in some embodiments, dynamically add more resources, such as more storage capacity or more computation capabilities, to accommodate new SLA requests. The use of the term “calibration” herein is meant as settings for the modeling methodology to determine if a new SLA can be accommodated and not about changing the storage system to accommodate new SLAs.

With dynamic resolution, the service module 152 can select varying levels of detail for assorted aspects of a current system performance and capabilities. That is, the service module 152 can alter what operational parameters are tracked, where the parameters are tracked, and how detailed those parameters are tracked. For instance, the service module 152 can choose to log one or more parameters, such as latency, error rate, consistency, capacity, and cost of data accesses, at different resolutions, such as one or more memory 112, memory die, memory plane, logical namespace, other physical/logical memory cell grouping, persistent storage sectors, persistent storage blocks, persistent storage devices, and persistent storage pools of devices. The ability to dynamically set what is tracked and what details are tracked allows the service module 152 to adapt to changing system and data request conditions with modeling resolution that provides the most accurate depiction of current system performance and capabilities without burdening, or jeopardizing, the satisfaction of existing SLAs.

The service module 152 may additionally adapt how future system performance and capabilities are modeled. Much like the dynamic resolution of current system performance and capabilities, the service module 152 can dynamically adapt the resolution for future system performance and capabilities, which can result in different resolutions for current and future system evaluations. It is contemplated that the computation of future system performance and capabilities can be more resource intensive for the service module 152 due to incorporating one or more hypothetical SLA terms and conditions to existing SLAs and current system operations. Hence, the service module 152 can identify what current and future system conditions are necessary to accommodate a new SLA, which allows for intelligent SLA evaluation without jeopardizing existing SLA satisfaction or degrading current, or near-future, system performance.

Through intelligent, dynamic use of system resources to model current and future performance and capabilities, the service module 152 can reserve ample system resources to compute the calibration requirements to ensure satisfaction of future SLA terms. In other words, adjusting the modeling of current and/or future system performance and capabilities provides enough system resources to calculate one or more system and/or data storage settings 176 that can increase the chance of satisfying terms of a requested SLA without degrading or jeopardizing satisfaction of existing SLA(s). The calibrations generated by the circuitry of the service module 152 can involve, for instance, moving data, altering logical grouping of data, changing how data is written/read, altering how data is cached/buffered, changing what background operations are conducted on memory cells, and changing what metadata is used to track data.

An example flowchart 190 of the operation of the data storage system 170 is shown in FIG. 5B. In step 192, a service module initially receives a request for a new SLA from a client/host that corresponds with a new QoS. Before accepting the SLA, the service module consults current system performance and capabilities in step 194 and subsequently uses those current conditions to predict future system performance and capabilities both with, and without, the new SLA in place in step 196.

The service module proceeds to generate one or more new calibration schemes in step 198 to optimize the chance of satisfying the new SLA with any other existing

SLAs. That is, step 198 evaluates current system calibrations with respect to the system performance needed to guarantee, or at least provide a high chance of continued operational success (>90%), satisfying existing and new SLAs. It is noted that the result of step 198 may be that no additional/new system calibrations are needed. However, it is also noted that step 198 may evaluate multiple different configurations, such as data placement, reference voltages, caching schemes, namespace sizes, background operations performed, and error correction conducted.

With the accumulation of the impact of the requested SLA on future system performance and capabilities, along with what calibrations would be needed to implement the SLA, the service module can intelligently determine if the new SLA request is to be accepted or declined in decision 200. A conclusion that the new system performance and/or new calibrations are too expensive in terms of time, processing, reliability, or power prompts the service module to return routine 190 to step 192. Conversely, if current calibrations to memory, data, and/or data access operations are sufficient to reliably service new and existing SLAs, step 202 conducts data storage operations with operational parameters that satisfy the new SLA while complying with any existing SLAs. It is noted that step 202 can be concurrently executed by the service module to comply with a variety of different operational parameter thresholds and/or ranges.

A block representation of an example service module 210 is depicted in FIG. 6 that can be utilized in the assorted data storage systems of FIGS. 1-5A. The service module 210 can employ one or more controllers 212, which can be any microprocessor or other programmable circuitry resident in one, or more, components of a data storage system. For example, a controller 212 may be circuitry resident in a network server, data storage device, or remote host that operate independently, or concurrently, to detect and/or determine at least a modeling strategy, settings strategy, current system performance, and predicted system capabilities.

A controller 212 can utilize one or more logs 214 that track selected system operations, such as latency, error rate, data position, background operations, and logical groupings of data. The storage of operations in a log 214 allows the controller 212 to quickly and efficiently compute current system performance, such as overall time to service a data access request or cost to store data in compliance with an SLA. Current and future system operations and capabilities can be computed by a performance circuit 216, as directed by the module controller 212.

The performance circuit 216 can intake assorted information, such as the current memory configuration, logged data accesses, and existing SLAs, to determine the real-time current performance and capabilities of a single data storage device, logical memory grouping, or the entirety of the system memory as a whole. The capabilities of the system are not limited, but can consist of the risk of the system not satisfying existing SLAs, available data capacity, available processor resources, and/or electrical power availability. The computation of current system performance and capabilities by the performance circuit 216 can be leveraged to generate future system performance and/or capabilities with one or more hypothetical changes in system operation in conjunction with a prediction circuit 218, such as new SLA, different numbers of connected client/hosts, changes in memory cell operation, and/or predicted alterations of data access request volume.

The prediction circuit 218 can employ the log 214 alone, or with one or more other detected system conditions, to generate at least one future event, condition, and/or operational parameter. For instance, the prediction circuit 218 can forecast future data access requests, memory errors, latency rates, and data access consistency that allows the performance circuit 216 to determine how the system would react and what operational consequences will result. The prediction of accurate future events may further be utilized by a settings circuit 220 to determine what data storage, and/or retrieval, parameters can be adjusted to optimize current system resource allocation and performance as well as guarantee satisfaction of future SLA terms. The settings circuit 220 can hypothetically test multiple different data and/or operational calibrations with the prediction circuit 218 to determine a settings strategy that prescribes how to react to changing system/data conditions to produce a desired data throughput, such as queue size, background operations schedule, buffer utilization, and error correction protocol.

A cost circuit 222 can provide the service module 210 with current, and future, expenses for various clients. That is, the cost circuit 222 can monitor, calculate, and/or speculate about how much data storage will cost for a client over time. In the event a client has a fixed cost term in an existing, or new, SLA, the cost circuit 222 can provide proactive and/or reactive actions to maintain the predetermined data storage cost with minimal system resource expenditure

It is noted that the proactive generation, and reactive modification, to the modeling strategy, and settings strategy by the service module 210 allows for efficient execution of the actions prescribed by the respective strategies. In contrast, a purely reactive evaluation of modifications to system performance/capability modeling, or calibration operations could burden the service module 210 and potentially degrade system performance, expend power unnecessarily, and jeopardize the satisfaction of one or more SLAs. Thus, the existence of the assorted strategies allows the service module 210 to provide optimized evaluation of a new SLA request and quickly respond to the request with an intelligent answer along with execution of actions that enable the new SLA to be satisfied.

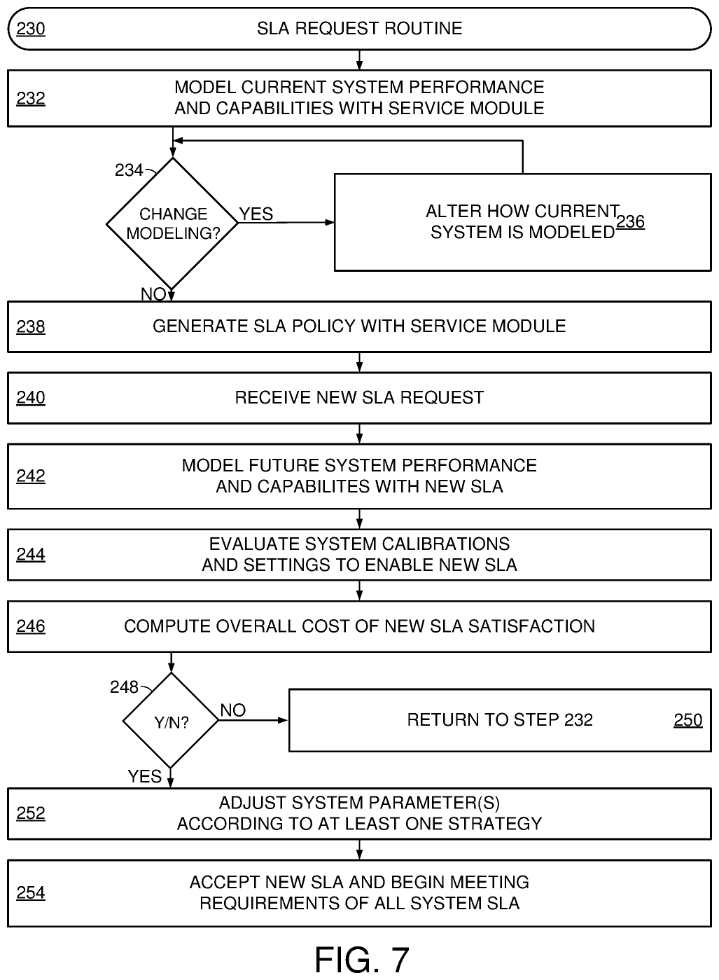

FIG. 7 is a flowchart of an example SLA request routine 230 that can be executed in a data storage system in accordance with various embodiments. The connection of at least one host/client to at least one data storage device via a service module enables step 232 to model current system performance and capabilities before, during, and after the host utilizes a data storage device to write, and retrieve, data. The modeling of step 232 can be conducted at one or more resolutions that track uniform, or varying, system conditions, such as memory cell health, data access latency, error rate, temperature, cache population, and queued data access requests. Decision 234 determines if the modeling of step 232 is to be changed. If so, step 236 alters at least one modeling parameter, such as what is tracked, what resolution is being used, and how often tracked conditions are refreshed.

Once current system performance and capabilities have been accurately modeled through one or more cycles of step 232, a service module generates an SLA policy in step 238 that dictates what SLA criteria and/or terms can be satisfied, which corresponds with what new SLAs the system can currently guarantee. The SLA policy can contain one or more permissions to accept, or deny, new SLA requests. It is contemplated that the SLA policy further contains permissions for some system components, such as individual data storage devices, logical memory groupings, or network nodes, to satisfy an existing SLA redundantly, or concurrently, with other system components.

The SLA policy can be initially consulted in step 240 in response to receipt of a new SLA request from an existing, or newly connected, host/client. While the existing SLA policy may preliminarily accept, or deny, the newly received SLA request, the service module can conduct an impact study to discover how the new SLA will affect system performance and capabilities. In a non-limiting impact study, the service module executes one or more existing strategies to model future system performance and capabilities in step 242, as discussed with respect to FIG. 6. The modeling of future system conditions can be utilized with the system calibrations that are needed to guarantee the new SLA, as generated by the service module, in step 244. The combination of the modeled future system performance, capabilities, and calibrations allows the service module to compute an overall cost of accepting the newly requested SLA in step 246. The overall cost can be characterized in any terms, such as system resources expended, time expended, risk to third-party attack, or any combination thereof.

Although the SLA policy may have indicated acceptance, or rejection, of the new SLA request without an impact study, which effectively skips steps 242-246, decision 248 determines if the new request is to be accepted in view of the results of steps 242-246. A rejection of the newly requested SLA prompts step 250 to return the routine 230 to step 232 where existing system conditions are modeled. An acceptance of the new SLA policy in decision 248 triggers step 252 to execute one or more actions from an existing strategy to begin conforming data, system components, and/or pending data access requests to guarantee, or at least provide a high chance (>90%), of continually satisfying the new SLA.

With system conditions optimized to satisfy existing and new SLAs, step 254 formally accepts the new SLA request via a prompt to the requesting host/client and proceeds to service data access requests in compliance with the terms of all SLAs. Some embodiments can execute 254 dynamically by adapting system conditions, data storage parameters, and/or position of data in memory to provide optimal expenditure of system resources during the satisfaction of existing SLAs.

As a result of the assorted embodiments of a service module, data storage systems can be optimized, particularly in systems where memories are shared by multiple users in a cloud/multi-tenant environment. By making smarter decisions with respect to entering SLAs, system administrators can better control use, access, and performance. Through the utilization of a service module that generates and maintains strategies that provide dynamic system modeling, settings, and SLA acceptance policies, a data storage system can intelligently react to changing memory and data access request conditions without jeopardizing existing SLA term satisfaction.

1. A method comprising:
connecting a service module to at least one host and a memory;
modeling a first data storage performance metric with the service module in accordance with a modeling strategy;
receiving, with the service module, a request for a new service level agreement;
evaluating, with the service module, an impact of the new service level agreement on an ability to guarantee existing service level agreements to the memory based on at least the first data storage performance metric;
computing, with the service module, a time to implement the new service level agreement based on the evaluated impact the new service level agreement; and
deciding, with the service module, to accept or deny the request for the new service level agreement in response to the computed time to implement the new service level agreement relative to a predetermined threshold value generated by the service module.

2. The method of claim 1, wherein the first data storage performance metric is modeled with a first resolution prior to receiving the request for the new service level agreement.

3. The method of claim 1, wherein the service module alters a first resolution to a second resolution in response to receiving the request for the new service level agreement.

4. The method of claim 3, wherein the second resolution has a die set level corresponding to tracking activity on each die set of a data storage device of the memory.

5. The method of claim 3, wherein the second resolution has a data storage device level corresponding to tracking activity on each data storage device of the memory.

6. The method of claim 1, wherein the service module concurrently tracks the first data storage performance metric with a first resolution and a second data storage performance metric with a second resolution, the first and second resolutions being different, the first and second data storage performance metrics being different.

7. The method of claim 1, wherein the first data storage performance metric is predicted by the service module in view of a second data storage performance metric.

8. The method of claim 1, wherein the service module alters the modeling of the first data storage performance metric to a second data storage performance metric proactively before accepting the request for the new service level agreement.

9. The method of claim 1, wherein the service module alters the modeling of the first data storage performance metric to a second data storage performance metric proactively after accepting the request for the new service level agreement.

10. A method comprising:
connecting a service module to at least one host and a memory;
tracking a plurality of operational parameters with the service module to determine a current performance of the memory;
modeling a first data storage performance metric of the memory with the service module in accordance with a modeling strategy from data access activity to the memory;
receiving, with the service module, a request for a new service level agreement;
generating, with the service module, a data storage setting of the memory to satisfy the new service level agreement;
evaluating, with the service module an impact of the new service level agreement on an ability to guarantee existing service level agreements to the memory based on at least the first data storage performance metric;
computing, with the service module, a time to implement the new service level agreement and data storage setting; and
deciding, with the service module, to accept or deny the request for the new service level agreement in response to the computed time to implement the new service level agreement and evaluated impact of the new service level agreement.

11. The method of claim 10, wherein the new service level agreement could not be guaranteed without the data storage setting.

12. The method of claim 10, wherein the data storage setting alters a reference voltage of at least one memory cell of the memory.

13. The method of claim 10, wherein the data storage setting alters what memory cells are in a logical grouping of memory cells in the memory.

14. The method of claim 10, wherein the data storage setting alters a memory cell from a multi-level configuration comprising more than two logical states to a single-level configuration comprising two logical states.

15. The method of claim 10, wherein a risk of failing to satisfy one or more existing service level agreements to the memory.

16. The method of claim 10, wherein the service module conducts the data storage setting to maintain satisfying terms of one or more existing service level agreements to the memory after accepting the new service level agreement.

17. The method of claim 10, wherein the service module concurrently evaluates multiple different requests for new service level agreements to the memory.

18. An apparatus comprising a service module connected to at least one host and a memory, the service module comprising circuitry to model more than one data storage performance metric and decide to accept or deny a request for a new service level agreement to the memory in view of an time to implement the new service level agreement and an impact of the new service level agreement on an ability to guarantee existing service level agreements to the memory.

19. The apparatus of claim 18, wherein a prediction circuit of the service module models future memory performance capability based on current performance tracked from the memory to generate the impact of the new service level agreement on the ability to guarantee existing service level agreements to the memory.

20. The apparatus of claim 18, wherein a cost circuit of the service module computes a cost of data storage for the new service level agreement.
